(19) United States
(12) Patent Application Publication
(10) Pub. No.: US 2011/0199024 A1
(43) Pub. Date: Aug. 18, 2011

(54) SINGLE CHIP BALLAST CONTROLLER CAPABLE OF PROVIDING BRIGHTNESS LEVELS OVERVIEW AND BRIGHTNESS SETTING OF A FLUORESCENT LAMP

(76) Inventors: Ko-Ming Lin, Tainan City (TW); Chang-Ling Sha, Taipei County (TW); Yen-Ping Wang, Taipei City (TW); Pei-Yuan Chen, Taipei County (TW); Yun-Chien Liao, Taipei County (TW)

(21) Appl. No.: 12/707,001

(22) Filed: Feb. 17, 2010

(51) Int. Cl. H05B 37/02

(52) U.S. Cl. 315/307

(57) ABSTRACT

The present invention discloses a single chip ballast controller, capable of providing brightness levels overview and brightness setting of a fluorescent lamp during power-on period, having: a switching detection circuit, used to generate a set signal, which changes from an inactive state to an active state when a supply voltage falls below a threshold voltage; a time-varying reference voltage generator, used to generate a time-varying reference voltage varying between a first level and a second level during a power-on period, wherein the time-varying reference voltage can be fixed at a level by the active state of the set signal during the power-on period; and a gating signal generator, used to generate a high side driving signal and a low side driving signal according to an error voltage between the time-varying reference voltage and a current sensing voltage.

### BACKGROUND OF THE INVENTION

1. Field of the Invention

The present invention relates to electronic ballasts for fluorescent lamps, and more particularly to ballast controllers capable of providing brightness levels overview and brightness setting of a fluorescent lamp.

2. Description of the Related Art

In supplying power to light emitting devices such as fluorescent lamps or cold cathode fluorescent lamps or compact fluorescent lamps, electronic ballasts are widely adopted to keep the lamp current stable.

To offer dimming function for electronic ballasts, some prior art ballast controllers have implemented a DIM input pin for receiving a DIM control voltage to provide a dimming control means. The DIM control voltage is generally generated by an additional dial switch (wall dimmer) or a remote control means, and users have to operate the additional dial switch or the remote control means other than an existing lamp rocker switch to trigger the electronic ballast to adjust the luminance of the lamp.

Through the setting of the DIM control voltage, a luminance of the fluorescent lamp corresponding to the setting of the DIM input is generated.

However, since the setting of the DIM control voltage in the prior art has to be done by manipulating an additional dial switch or a remote control means other than an existing lamp switch, users have to pay more cost for the additional dial switch or remote control means. Besides, the additional dial switch may have to be mounted on the wall wherein the wiring between the dial switch and the ballast is bothersome. As to the remote control means, the communication between the transmitter and the receiver needs power, and if the remote control means runs out of battery, then there is no way to dim the lamp unless the battery is replaced.

Therefore, there is a need to provide a solution capable of reducing the cost and eliminating the requirement of an additional dial switch or remote control means in implementing a ballast application with dimming function.

Seeing this bottleneck, the present invention proposes a novel topology of a single chip ballast controller capable of providing brightness levels overview and brightness setting of a fluorescent lamp by switching a corresponding lamp switch, without the need of any additional dial switch or remote control means.

### SUMMARY OF THE INVENTION

One objective of the present invention is to provide a ballast controller capable of providing brightness levels overview and brightness setting of a fluorescent lamp by sensing the switching of a power line, without the need of any additional dial switch or remote control means.

Another objective of the present invention is to provide a ballast controller with brightness adjusting function which is controlled by the switching of a corresponding lamp switch.

Still another objective of the present invention is to provide a single chip ballast controller with concise architecture, which can control the luminance of the lamp by regulating the lamp current according to a settled level of a time-varying reference voltage determined by the switching of a corresponding lamp switch.

To achieve the foregoing objectives, the present invention provides a single chip ballast controller, capable of providing brightness levels overview and brightness setting of a fluorescent lamp during power-on period, comprising: a switching detection circuit, used to generate a set signal, which changes from an inactive state to an active state when a supply voltage falls below a threshold voltage; a time-varying reference voltage generator, used to generate a time-varying reference voltage varying gradually between a first level and a second level during a power-on period, wherein the time-varying reference voltage can be fixed at a level between the first level and the second level by the active state of the set signal during the power-on period; and a gating signal generator, used to generate a high side driving signal and a low side driving signal according to an error voltage between the time-varying reference voltage and a current sensing voltage in a way that the high level durations of the high side driving signal and the low side driving signal vary in the same direction as the amplitude of the error voltage, wherein the current sensing voltage is proportional to a lamp current flowing through the fluorescent lamp.

To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1 is a block diagram of a ballast circuit comprising a ballast controller capable of providing brightness levels overview and brightness setting of a fluorescent lamp during power-on period according to a preferred embodiment of the present invention.

FIG. 2 is a detailed block diagram of a ballast controller capable of providing brightness levels overview and brightness setting of a fluorescent lamp during power-on period according to a preferred embodiment of the present invention.

FIG. 3a shows a time-varying reference voltage waveform during the power-on period.

FIG. 3b shows a time-varying reference voltage waveform with a setting during the power-on period.

FIG. 4 is a detailed block diagram of the gating signal generator in FIG. 2 according to a preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

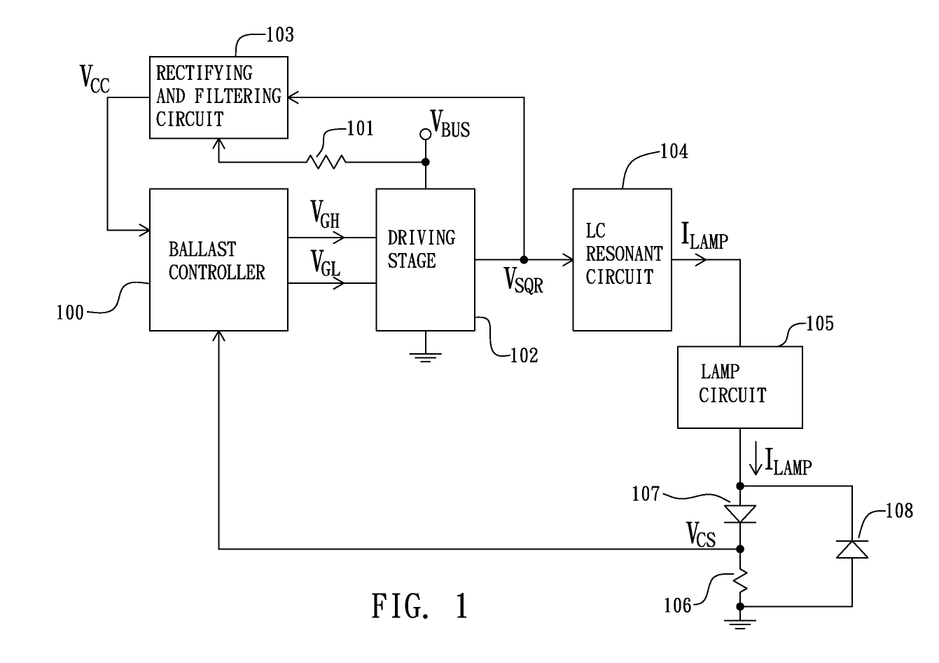

Please refer to FIG. 1, which shows a block diagram of a ballast circuit comprising a ballast controller capable of providing brightness levels overview and brightness setting of a fluorescent lamp during power-on period according to a preferred embodiment of the present invention. As shown in FIG. 1, the ballast circuit comprises a ballast controller 100, a start-up resistor 101, a driving stage 102, a rectifying and filtering circuit 103, a LC resonant circuit 104, a lamp circuit 105, a current sensing resistor 106 and diodes 107-108.

The ballast controller 100 is used to generate a pair of non-overlapping driving signals composed of a high side driving signal V_{GH} and a low side driving signal V_{GL} according to an error voltage between a time-varying reference voltage and a current sensing voltage V_{CS} (non-negative), wherein the current sensing voltage V_{CS} is generated according to a lamp current I_{LAMP}. The high level durations of the high side driving signal V_{GH} and the low side driving signal V_{GL}, non-overlapping with each other, are controlled by the error voltage in a way that the high level durations of the high side driving signal V_{GH} and the low side driving signal V_{GL} vary in the same direction as the error voltage, so when the error voltage increases—it means the lamp current I_{LAMP} is below an expected value—the high level durations of the high side driving signal V_{GH} and the low side driving signal V_{GL} will be prolonged to have more energy delivered to the lamp circuit 105 to increase the lamp current I_{LAMP}. For a given level of the time-varying reference voltage, the error voltage will be settled to a corresponding value in a finite period, and the also settled high level durations of the pair of non-overlapping driving signals will then result a corresponding brightness level of the fluorescent lamp.

The time-varying reference voltage generated inside the ballast controller 100 is varying gradually between a first level and a second level during a power-on period, and will be fixed at a level between the first level and second level when a switching of a power line V_{BUS} causes a supply voltage V_{CC} to fall below a threshold voltage. After the level of the time-varying reference voltage fixed, it can be further increased by switching the power line V_{BUS} a first number of times (for example one time) in an adjustment period, or decreased by switching the power line V_{BUS} a second number of times (for example two times) in the adjustment period, so users can adjust the time-varying reference voltage up or down to a satisfied level within a plurality of the adjustment periods.

The start-up resistor 101, coupled to the rectifying and filtering circuit 103, is used to provide a start-up current path for building the supply voltage V_{CC} from a main input voltage V_{BUS}.

The driving stage 102, powered by the power line V_{BUS}, is used to generate a square signal V_{SQR} at an output end with a high level and a low level according to the high side driving signal V_{GH} and the low side driving signal V_{GL}. The high level of the square signal V_{SQR} is provided by connecting the output end through a first switch—turned on in the high level duration of the high side driving signal V_{GH}—to the main input voltage V_{BUS}, and the low level of the square signal V_{SQR} is provided by connecting the output end through a second switch—turned on in the high level duration of the low side driving signal V_{GL}—to a reference ground. The first switch preferably comprises a high side NMOS transistor and the second switch preferably comprises a low side NMOS transistor.

The rectifying and filtering circuit 103 is used to provide the supply voltage V_{CC}. In the start-up period, the supply voltage V_{CC} is charged up by the main input voltage V_{BUS} via the start-up resistor 101 to enable the ballast controller with step-dimming function 100 to generate the high side driving signal V_{GH} and the low side driving signal V_{GL}, and thereby the square signal V_{SQR} of the driving stage 102. The rectifying and filtering circuit 103 then rectifies and filters the square signal V_{SQR} to generate the supply voltage V_{CC}.

The LC resonant circuit 104 acts as a band-pass filter to process the square signal V_{SQR} to generate the lamp current I_{LAMP} having a resonant waveform.

The lamp circuit 105 comprises a fluorescent lamp of which the luminance varies in the same direction as the root-mean-squared value of the lamp current I_{LAMP}.

The current sensing resistor 106 is used to carry the positive portions of the lamp current I_{LAMP}, by the unilateral switching of the diode 107, to provide the current sensing voltage V_{CS}, and the diode 108 is used to clamp the anode voltage of the diode 107 at around −0.7V when the lamp current I_{LAMP} is in negative half cycles.

As the time-varying reference voltage varies gradually between the first level and second level, the high side driving signal V_{GH} and the low side driving signal V_{GL} will cause the average of the current sensing voltage V_{CS} to approach the time-varying reference voltage, thereby providing a brightness levels overview of the fluorescent lamp, and users can choose a preferred brightness level during the overview by switching the power line V_{BUS}. Besides, the ballast controller 100 can be a single chip or it can be integrated with the driving stage 102 into a single chip.

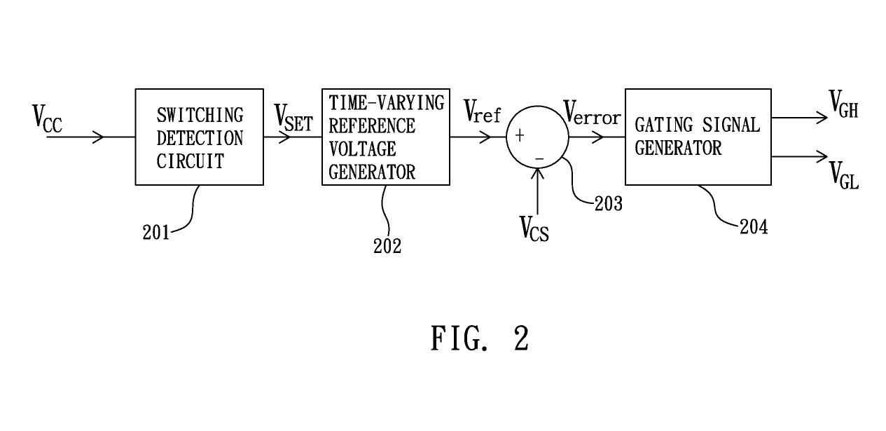

Please refer to FIG. 2, which shows a detailed block diagram of a ballast controller according to a preferred embodiment of the present invention. As shown in FIG. 2, the ballast controller comprises a switching detection circuit 201, a time varying reference voltage generator 202, a combiner 203 and a gating signal generator 204.

The switching detection circuit 201 preferably comprises a comparator. The comparator is used to generate a set signal V_{SET}, wherein the set signal V_{SET} changes from an inactive state to an active state when the supply voltage V_{CC} falls below a threshold voltage.

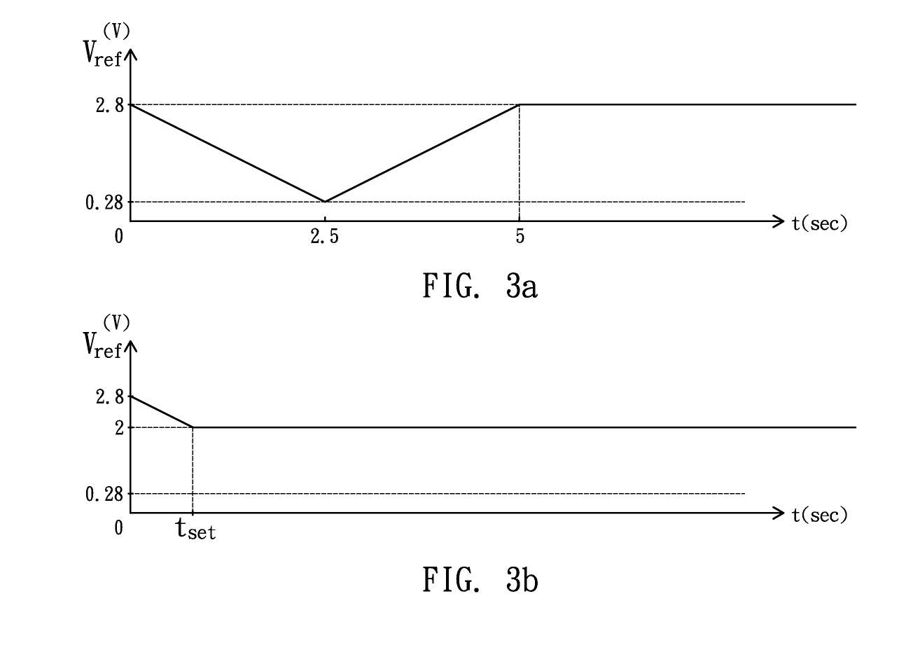

The time-varying reference voltage generator 202, for example but not limited to waveform generator, is used to generate a time-varying reference voltage V_{ref} varying gradually between a first level and a second level during the power-on period. Please refer to FIG. 3a, which shows an exemplary waveform of the time-varying reference voltage V_{ref} during the power-on period. As shown in FIG. 3a, the first level is 2.8V, the second level is 0.28V, and the power-on period is 5 sec. The time-varying reference voltage V_{ref} decreases gradually in the first half of the power-on period and then increases gradually in the second half of the power-on period. The time-varying reference voltage V_{ref} can be fixed at a level between the first level and second level by the first occurrence of the active state of the set signal V_{SET} during the power-on period. Please refer to FIG. 3b, which shows the waveform of the time-varying reference voltage V_{ref} with a setting during the power-on period. As shown in FIG. 3b, the level of the time-varying reference voltage V_{ref} is fixed at 2V at the instant of tₛₑₜ. The time-varying reference voltage generator 202 also provide a function that the level of the time-varying reference voltage V_{ref} can then be increased by a first number (for example one) of the active states in an adjustment period, or decreased by a second number (for example two) of the active states in the adjustment period, so users can adjust the time-varying reference voltage V_{ref} up or down to a satisfied level within a plurality of the adjustment periods.

The combiner 203 is used to subtract the time-varying reference voltage V_{ref} with the current sensing voltage V_{CS} to generate an error voltage Vₑᵣᵣₒᵣ. The amplitude of the error voltage Vₑᵣᵣₒᵣ varies in the same direction as the brightness of the fluorescent lamp because the amplitude of the current sensing voltage V_{CS} is proportional to that of the lamp current I_{LAMP}, and the larger the amplitude of the lamp current is, the brighter the fluorescent lamp will be.

The gating signal generator 204 is used to generate the high side driving signal V_{GH} and the low side driving signal V_{GL} according to the error voltage Vₑᵣᵣₒᵣ in a way that the high level durations of the high side driving signal V_{GH} and the low side driving signal V_{GL} vary in the same direction as the amplitude of the error voltage Vₑᵣᵣₒᵣ.

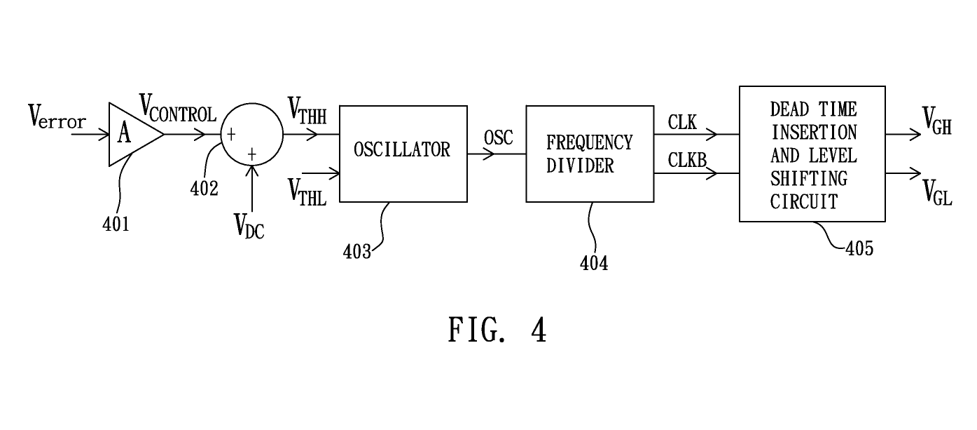

A preferred embodiment of the gating signal generator 204 is disclosed in FIG. 4. Please refer to FIG. 4, which shows a detailed block diagram of the gating signal generator 204 in FIG. 2 according to a preferred embodiment of the present invention. As shown in FIG. 4, the gating signal generator comprises an amplifier 401, a combiner 402, an oscillator 403, a frequency divider 404 and a dead time insertion and level shifting circuit 405.

The amplifier 401 amplifies the error voltage Vₑᵣᵣₒᵣ (for example but not limited to 0˜10 mV_{P-P}) with a gain (for example but not limited to 100V/V) to generate a control voltage V_{CONTROL} (for example but not limited to 0˜1V_{P-P}).

The combiner 402 is used to add the control voltage V_{CONTROL} with a DC voltage V_{DC} to generate a high threshold voltage V_{THH}, wherein the DC voltage V_{DC}, for example but not limited to 3.8V, is used to define a minimum brightness level.

The oscillator 403, preferably but not limited to an astable type, is used to generate an oscillating signal OSC according to the high threshold voltage V_{THH} and a low threshold voltage V_{THL}. The frequency of the oscillating signal OSC varies in the opposite direction as the high threshold voltage V_{THH}, i.e., as the level of the high threshold voltage V_{THH} goes up/down, the frequency of the oscillating signal OSC will become lower/higher.

The frequency divider 404 is used to divide the frequency of the oscillating signal OSC to generate a pair of complementary clock signals CLK and CLKB.

The dead time insertion and level shifting circuit 405 is used to insert a dead time between the pair of complementary clock signals CLK and CLKB and up shift the pair of complementary clock signals CLK and CLKB to generate the high side driving signal V_{GH} and the low side driving signal V_{GL}.

Through the implementation of the present invention, a single-chip ballast controller capable of providing brightness levels overview and brightness setting of a fluorescent lamp during power-on period by sensing the switching of a lamp switch and sensing the lamp current is presented. The topology of the present invention is much more concise than prior art circuits, so the present invention does conquer the disadvantages of prior art circuits.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A single chip ballast controller, capable of providing brightness levels overview and brightness setting of a fluorescent lamp during power-on period, comprising:
a switching detection circuit, used to generate a set signal, which changes from an inactive state to an active state when a supply voltage falls below a threshold voltage;
a time-varying reference voltage generator, used to generate a time-varying reference voltage varying between a first level and a second level during a power-on period, wherein said time-varying reference voltage can be fixed at a level between said first level and said second level by said active state of said set signal during said power-on period; and
a gating signal generator, used to generate a high side driving signal and a low side driving signal according to an error voltage between said time-varying reference voltage and a current sensing voltage in a way that the high level durations of said high side driving signal and said low side driving signal vary in the same direction as the amplitude of said error voltage, wherein said current sensing voltage is proportional to a lamp current flowing through said fluorescent lamp.

2. The single chip ballast controller as claim 1, wherein said time-varying reference voltage has a decreasing period and an increasing period during said power-on period.

3. The single chip ballast controller as claim 1, wherein said gating signal generator comprises:
an amplifier, used to amplify said error voltage to generate a control voltage;
a combiner, used to generate a high threshold voltage according to the sum of said control voltage and a DC voltage;
an oscillator, used to generate an oscillating signal according to said high threshold voltage and a low threshold voltage, wherein the frequency of said oscillating signal is inversely controlled by the level of said high threshold voltage;
a frequency divider, used to divide the frequency of said oscillating signal with a number to generate a pair of complementary clock signals; and
a dead time insertion and level shifting circuit, used to insert a dead time between said pair of complementary clock signals and up shift said pair of complementary clock signals to generate said high side driving signal and said low side driving signal.

4. The single chip ballast controller as claim 1, further comprising a driving stage with an output end for generating a square signal with a high level and a low level according to said high side driving signal and said low side driving signal, wherein said high level is provided by connecting said output end through a first switch to a main input voltage and said low level is provided by connecting said output end through a second switch to a reference ground.

5. The single chip ballast controller as claim 4, wherein said first switch comprises a high side NMOS transistor, and said second switch comprises a low side NMOS transistor.

6. The single chip ballast controller as claim 1, wherein said switching detection circuit comprises:
a comparator, used to compare said supply voltage with said threshold voltage to generate said set signal.

7. The single chip ballast controller as claim 1, wherein said time-varying reference voltage generator comprises a waveform generator.

8. A single chip ballast controller, capable of providing brightness levels overview and brightness setting of a fluorescent lamp during power-on period, comprising:
a switching detection circuit, used to generate a set signal, wherein said set signal changes from an inactive state to an active state when a supply voltage falls below a threshold voltage;
a time-varying reference voltage generator, used to generate a time-varying reference voltage varying between a first level and a second level during a power-on period, wherein said time-varying reference voltage can be fixed at a level between said first level and said second level by said active state of said set signal during said power-on period, and the level of the time-varying reference voltage V_{ref} can then be increased by a first number of the active states in an adjustment period, or decreased by a second number of the active states in the adjustment period; and
a gating signal generator, used to generate a high side driving signal and a low side driving signal according to an error voltage between said time-varying reference voltage and a current sensing voltage in a way that the high level durations of said high side driving signal and said low side driving signal vary in the same direction as the amplitude of said error voltage, wherein said current sensing voltage is proportional to a lamp current flowing through said fluorescent lamp.

9. A single chip ballast controller, capable of providing brightness levels overview and brightness setting of a fluorescent lamp during power-on period, comprising:
a switching detection circuit, used to generate a set signal, wherein said set signal changes from an inactive state to an active state when a supply voltage falls below a threshold voltage;
a time-varying reference voltage generator, used to generate a time-varying reference voltage varying between a first level and a second level during a power-on period, wherein said time-varying reference voltage can be fixed at a level between said first level and said second level by said active state of said set signal during said power-on period, and the level of the time-varying reference voltage V_{ref} can then be increased by a first number of the active states in an adjustment period, or decreased by a second number of the active states in the adjustment period;
a gating signal generator, used to generate a high side driving signal and a low side driving signal according to an error voltage between said time-varying reference voltage and a current sensing voltage in a way that the high level durations of said high side driving signal and said low side driving signal vary in the same direction as the amplitude of said error voltage, wherein said current sensing voltage is proportional to a lamp current flowing through said fluorescent lamp; and
a driving stage, having an output end for generating a square signal with a high level and a low level according to said high side driving signal and said low side driving signal, wherein said high level is provided by connecting said output end through a first switch to a main input voltage and said low level is provided by connecting said output end through a second switch to a reference ground.
